(19) United States
(12) Patent Application Publication
(10) Pub. No.: US 2004/0135279 A1
(43) Pub. Date: Jul. 15, 2004

(54) Method of manufacturing a plastic encapsulated structural member

(76) Inventors: Anthony P. Habodasz, Troy, OH (US); Michael D. Johnson, Cincinnati, OH (US); Donald J. Thomas, Milford, OH (US)

Correspondence Address: MATTINGLY, STANGER & MALUR, P.C., 1800 DIAGONAL ROAD, SUITE 370, ALEXANDRIA, VA, 22314, US

(21) Appl. No.: 10/733,576

(22) Filed: Dec. 12, 2003

Related U.S. Application Data
(60) Provisional application No. 60/439,471, filed on Jan. 13, 2003.

(51) Int. Cl. B29C 44/12

(52) U.S. Cl. 264/46.4; 264/85

(57) ABSTRACT

A method of manufacturing a plastic encapsulated plastic structural member includes the steps of forming a mold having first and second mold parts which form an enclosed mold defining a cavity therein having a configuration the same as the configuration of this structural member to be formed. A core of wooden material having holes on each of two opposed surfaces is formed and positioned in the cavity so that pins on the mold parts engage the holes. A foamable plastic material and nitrogen is injected under low pressure into the cavity to cause the plastic material to foam up and fill the space between the core and the cavity all around the core. The plastic material is then allowed to harden to form a plastic layer around the core. The mold parts are then removed. The holes may be closed with the plug of additional plastic material.

### BACKGROUND OF THE INVENTION

The invention relates to a method of manufacturing a plastic encapsulated structural member and, more particularly, to a method of manufacturing such a structural member having a core of wood material encapsulated by a layer of a suitable polymeric resin such as polyethylene or polypropylene.

Wooden structural members have found wide use in many applications such as in playground equipment, docks, landscaping, decking, fencing and floatation devices. Such wooden structural members can deteriorate over time as a result of weather conditions, moisture, wood destroying organisms and splintering. In order to protect these wooden members, they are often treated with a pressurized process for embedding and/or coating the outside of the wooden members with protective chemicals and the like. Even with such pressure treated wood members, however, deterioration occurs over time. Moreover, the chemicals may contaminate a surrounding area as the wood deteriorates.

To better protect wooden structural members, such members have been encapsulated with plastic to increase their durability and to withstand deterioration for a longer period of time then pressure treated wood structures. In forming plastic encapsulated wood structural members, however, there have been difficulties such as adequately adhering or bonding the plastic material to the wood. Prior methods of manufacturing the plastic encapsulated structural members also have been relatively complex and expensive.

### SUMMARY OF THE INVENTION

It is an object of the present invention to provide a method of manufacturing a plastic encapsulated structural member which encapsulates a core in a layer of a plastic material.

It is another object of the invention to provide a method of manufacturing a plastic encapsulated structural member by encapsulating a core of wood material with a layer of a suitable plastic material such as a polymeric resin having an elastomer added thereto.

It is further object of the invention to provide a method of manufacturing a plastic encapsulated structural member by putting a core of wood material into a mold, closing the mold and injecting a foamable plastic material such as high density polyethylene using a low pressure nitrogen injection process which forms a protective layer of plastic on all surfaces of the core, including the ends.

The present invention achieves the above and other objects by providing a method of manufacturing a plastic encapsulated structural member which includes the steps of forming a mold having opposing first and second mold parts which, when mated together, form an enclosed mold defining a cavity therein. One of the mold parts is movable and the other is stationary. The cavity has a configuration the same as the configuration of the structural member to be formed. The first and second mold parts each have a plurality of spaced pins mounted thereon which extend into the interior of the cavity when the first and the second parts are mated together whereby the pins on the first mold part are in a directly opposed relationship to the pins on the second mold part in the interior of the cavity. Each of the pins includes an enlarged cylindrical base portion attached to a mold part and a circular shaft portion extending therefrom.

The method further includes forming a core of wood material having a configuration which is the same as the configuration of the structural member to be manufactured. The core is provided with a plurality of holes on each of two opposed surfaces of the core which are spaced apart a distance equal to a distance between the spaced pins on the first and the second mold parts. The holes on each of the two opposed surfaces of the spaced member are formed by constructing through holes which extend all away through the core member.

The core is than positioned in the cavity of the mold so that the pins on the first and the second mold parts engage the holes in the cores to hold the core in a position spaced from all surfaces of the cavity including the end surfaces. The enlarged base portions of the pins abut against the opposed surfaces of the core to retain the core in spaced relationship from all surfaces of the cavity of the mold.

A foamable plastic material such as high density polyethylene is injected along with nitrogen under a low pressure through an injection nozzle or opening in one of the mold parts into the cavity until the mold is approximately 80% filled. The injected plastic material foams up and fills the entire space between the core and all surfaces of the cavity around the core. The foamed plastic material is then allowed to harden around the core to encapsulate the core with a hardened layer of foamed plastic that is firmly bonded to the outer surface of the wood core. The first and the second mold parts are then removed from the encapsulated core so that the pins are withdrawn from the core to leave openings corresponding to the pins exposed on opposing or top and bottom surfaces of the core.

A plug constructed of the same plastic material as the plastic injected into the mold, is then placed into an enlarged opening on the top of each hole in the plastic material formed by the head portion of each pin. The plug is welded in place in the enlarged opening by a sonic welding process to close the end of the hole with the plug of plastic material.

These and other features advantages of the present invention but will become more apparent with reference to the following detailed description in drawings.

### BRIEF DESCRIPTION OF THE DRAWINGS

FIG. 1 is a plan view of a molding machine according to the present invention showing the side of the machine having the moving parts of each mold;

FIG. 2 is a partial sectional view taking along line A-A of FIG. 1 showing plastic encapsulated structural members contained within cavities of the molds;

FIG. 3 is a cross sectional view of a plastic encapsulated structural member showing the ends of a hole in the wooden core closed by a plastic plug; and

FIG. 4 is a cross-sectional view of a plastic encapsulated structural member showing a hole in the wood core and the plastic plugs situated outside of the ends of the hole prior to being welded.

### DETAILED DESCRIPTION OF THE PREFERRED EMBODIMENTS

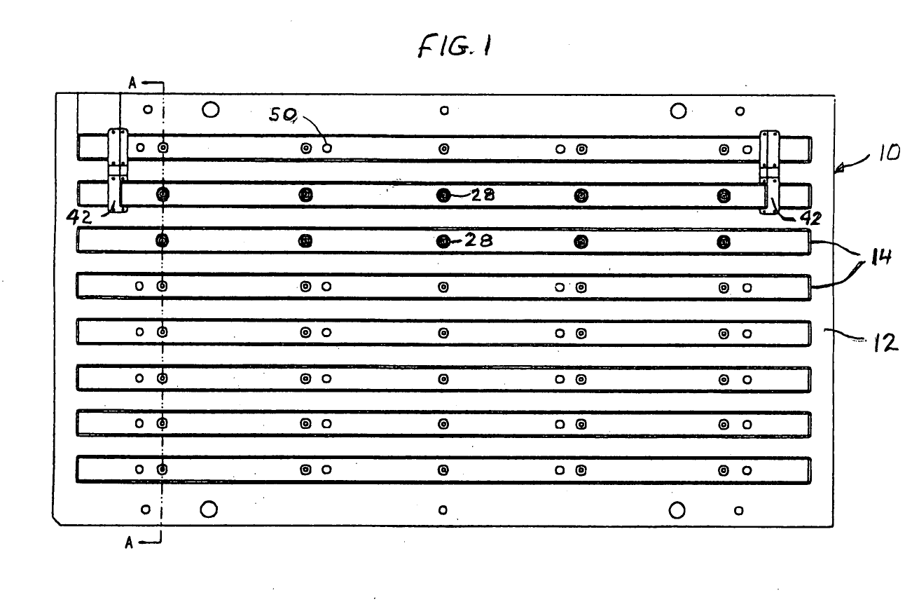

As shown in FIG. 1, a molding machine, generally indicated by the numeral 10, has a frame 12 which supports a plurality of spaced, parallel molds 14.

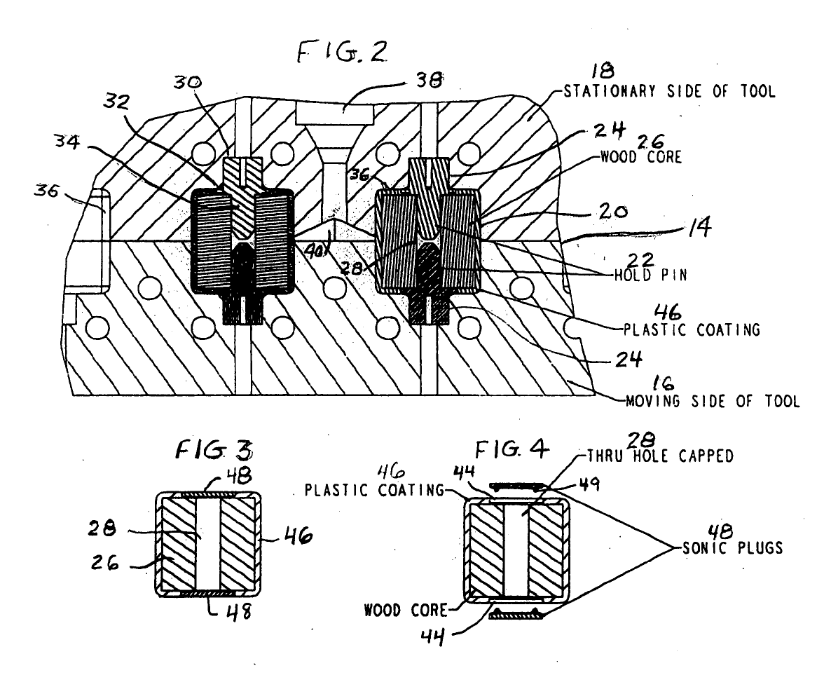

As shown in the cross-sectional view of FIG. 2, each mold has a moving part or side 16 which mates with a stationary part or side 18 to define a mold cavity 20 extending along the length thereof. The second and third molds from the top of FIG. 1 are shown with the moving side 16 of the molds removed. Holding pins 22 are mounted in openings 24 in each of the moving side and the stationary side of each mold whereby each holding pin in a moving side of a mold is directly opposite to a holding pin in a stationary side of a mold.

A wood core 26 is positioned in the cavity of each mold. The wood core may be made of engineered woods such as a plurality of laminations or layers bonded together or a plurality of chips held together by a binder material. The wooden core also may be made of a single piece of wood.

A plurality of holes 28 are formed to extend all away through the wood core from opposing surfaces such as the top surface and bottom surface as shown in FIG. 2. Alternatively, individual or single holes may be formed extending into the wood core from opposite surfaces. A single through hole, however, is preferred. The number of holes 28 in each wood core correspond to the number of pairs of opposed holding pins 22 mounted in the stationary and moving sides of each mold.

As also shown in FIG. 2, each holding pin 22 has a base portion 30 having an enlarged cylindrical lip or shoulder 32 extending therefrom and a shaft portion 34 of smaller diameter extending inwardly from the lip portion. The lip portion 32 of each holding pin 22 abuts against the wood core on its inner end and against a wall of the cavity 20 on its outer end to create a space 36 between the wood core member 26 and the walls of the cavity 20 while firmly holding the wood core 26 in the center of the cavity.

An injection nozzle 38 is provided in one of the sides of the mold for injecting a suitable plastic material such as high density polyethylene using a low pressure nitrogen injection process. Preferably the nozzles are mounted in the stationary side 18 of the mold as shown in FIG. 2. If necessary, a plurality of nozzles may be used along the length of each mold. As further shown in FIG. 2, one nozzle may be used to inject the plastic into two adjacent molds through the use of a fangate 40 at the inner end of the nozzle.

The injected plastic material preferably is a suitable polymeric resin with an elastomer added. High density polyethylene and polypropylene are particularly suitable polymeric resins. The plastic is injected under a low pressure nitrogen injection process whereby a typical low pressure may be 500 psi. Moreover, the plastic material may have an additive added to it to cause it to glow in the dark. A coloring agent also may be added to the plastic material to give the structural member a desired color.

The foamable plastic material is injected into the mold using the low pressure nitrogen injection process until the cavity of the mold is approximately 80 percent full. The injected plastic material then foams up and fills the entire space between the core and all surfaces of the cavity around the core. The foaming occurs due to the fact that the nitrogen bubbles are small when first introduced into the mold cavity but subsequently expend to cause the plastic to foam.

The foamed plastic is then allowed to harden around the core to encapsulate the core with a hardened layer of foamed plastic which forms a strong bond with the surface of the core on all sides thereof, including the ends. A preferred thickness of the plastic layer is in the range of ¼ inch to ⅜ inch.

As shown in FIG. 1, the molds have an insert 42 adjustably positioned at each end thereof. By adjusting the position of the inserts at the ends of each mold the length of the cavity of a mold may be adjusted to different sizes. In addition to the approximately square shape of each mold shown in FIG. 2, other suitable configurations may be used such as a circular mold having a corresponding circular cavity therein to form a circular or cylindrical structural member or a rectangular configuration to form a rectangular structural member.

After the foamed plastic material has sufficiently hardened to form a securely bonded layer of plastic on the outside of the wood core, the moving side 16 of the mold is removed from the stationary side of the mold. As shown in FIG. 1, ejector pins 50 are provided in the movable side of each mold. The holding pins 22 are also removed from the wood core so that the through hole 28 is exposed on two opposite surfaces of the structural member as shown in FIG. 4. Moreover, the enlarged lip or shoulder portion 32 of the each holding pin 22 forms an enlarged opening 44 at each end of the hole as shown in FIG. 4.

Plugs 48 of the same plastic material as the plastic layer are utilized to fill in or close each end of each through hole 28 by a sonic welding process. As shown in FIG. 4 each plug 48 has a small circular ridge 49 of the plastic material on one side thereof whereby when the plug is fitted into an enlarged opening 44 at one end of a through hole and welding performed, the plastic material in the circular ridge melts to help secure the weld plug in the enlarged opening.

Numerous other modifications and adaptations of the invention will be apparent to those skilled in the art and thus, it is intended by the following claims to cover all such modifications and adaptations which fall within the spirit and scope of the invention.

We claim:

1. A method of manufacturing a plastic encapsulated structural member comprising the steps of:
forming a mold having opposing first and second mold parts which, when mated together, form an enclosed mold defining a cavity therein having a configuration the same as the structural member to be manufactured;
said first and second mold parts each having at least two spaced pins mounted thereon and extending into said cavity when said first and second parts are mated together whereby said at least two pins on said first mold part are in opposed relationship to said at least two pins on said second mold part in said cavity;
forming a core of wood material having a configuration the same as the structural member to be manufactured;
providing at least two holes on each of two opposed surfaces of said core spaced apart a distance equal to a distance between said spaced pins on said first and second mold parts;
positioning said core in said cavity so that said pins on said first and second mold parts engage said holes in said core to hold said core in a position spaced from all surfaces of said cavity;
injecting a formable plastic material and nitrogen under low pressure into said cavity to cause said plastic material to foam up and fill a space between said core and said cavity all around said core;
allowing said foamed plastic material to harden around said core to encapsulate said core with a plastic layer; and
removing said first and second mold parts from said encapsulated core so that said pins are withdrawn from said core to leave said holes exposed.

2. A method of manufacturing a plastic encapsulated structural member according to claim 1 wherein said mold is adjustable in length and the method further includes the step of adjusting the length of said mold to a specified length.

3. A method of manufacturing a plastic encapsulated structural member according to claim 1 wherein said holes are through holes extending through said core.

4. A method of manufacturing a plastic encapsulated structural member according to claim 1 wherein each said pin has a shoulder of a larger diameter than the diameter of a body of said pin and the method further includes the step of forming an outer opening of a larger diameter than the diameter of each of said holes in the core.

5. A method of manufacturing a plastic encapsulated structural member according to claim 1 which further includes the step of forming said plastic layer to a thickness of ¼ inch to ⅜ inch.

6. A method of manufacturing a plastic encapsulated structural member according to claim 1 which further includes the step of closing each of said holes by inserting a plug of the same plastic material as used to form said plastic layer, into each said hole and securing the plug therein.

7. A method of manufacturing a plastic encapsulated structural member according to claim 4 which further includes the step of closing each of said holes by inserting a plug of the same plastic material as used to form said plastic layer, into said opening of each said hole and securing the plug therein.

8. A method of manufacturing a plastic encapsulated structural member according to claim 7 wherein said plug has a circular ridge on surface thereof and said plug is secured in said opening by a welding process.
